(19) United States
(12) Patent Application Publication
(10) Pub. No.: US 2004/0042645 A1
(43) Pub. Date: Mar. 4, 2004

(54) Fingerprint recognition method, and fingerprint control method and system

(75) Inventor: Li Wang, Jilin (CN)

Correspondence Address: COHEN, PONTANI, LIEBERMAN & PAVANE, 551 Fifth Avenue, Suite 1210, New York, NY, 10176, US

(73) Assignees: Changchun Hongda Optoelectronic; Biostatistics Identification Technology Co., Ltd.

(21) Appl. No.: 10/294,231

(22) Filed: Nov. 14, 2002

(30) Foreign Application Priority Data
Sep. 4, 2002 (CN) 02132297.X

(51) Int. Cl. G06K 9/00

(52) U.S. Cl. 382/125

(57) ABSTRACT

The present invention relates to a fingerprint recognition method, a fingerprint control method and a fingerprint control system. The fingerprint recognition method includes following steps: calculating a direction field and a quality field of the obtained fingerprint image, and judging whether the fingerprint quality is qualified or not; filtering and bianarizing the image of the qualified fingerprints, and extracting the characteristic data of the fingerprints on the binarized fingerprint image; comparing the extracted characteristic data of the fingerprints with the fingerprints in the fingerprint characteristic data memory, and obtaining the recognition result according to the comparison, wherein, the direction field of the fingerprint image is locally corrected by use of the local preponderance method. The fingerprint control system according to the present invention can be used conveniently, has a low rejection ratio or low mis-recognition ratio, and is of important application value.

### FIELD OF TECHNOLOGY

The invention relates to a fingerprint recognition method, and a fingerprint control method and a fingerprint control system.

### BACKGROUND ART

Over a long period of time, when there is a need for verifying one's identity in human society, a conventional method is to verify whether he or she possesses an effective certificate or authenticating object, such as a cipher code, a key, a magnetic card, an IC card or the like. Essentially, this method is to verify that he or she possesses some kind of “object”, rather than to verify his or her own. As long as the effectiveness of the “object” is verified, the identity of the person, who possesses the “object”, is verified accordingly. The unreliability of this object-based person verifying method is obvious. First, if a legal person loses the objects (such as a key, a cipher code or the like) verifying his or her identity, the legal person's own cannot be verified legally. Next, various counterfeit certificates, authenticating objects and the deciphering and embezzlement of the cipher codes make illegal persons be verified legally. Therefore, it has begun to search for a person-based (not object-based) direct recognition method, as so called “human body biological characteristic identity recognition technology”.

The several existing identity verification methods are summarized as follows:

(1) mechanical method, mainly including the use of mechanical keys or the like; (2) electronic recognition method, mainly including the use of magnetic cards, IC cards, radio frequency cards, intelligent cards, cipher codes etc.; (3) biological characteristic recognition method, mainly including the technology that the identity is verified by use of human fingerprints, palm prints, iris and DNA or other biological characteristics. The use of identity verification methods mentioned above has following defects.

(1) The recognition media in the recognition technologies mentioned above are easy to be damaged. For example, the magnetic cards, when being long-term used, would be damaged, and need to be replaced or renewed. In addition, there exist the cases that such as keys and IC cards are damaged to different extents.

(2) The recognition media in the recognition technologies mentioned above are easy to be lost or to be stolen. For example, the keys may be stolen and also may be lost because of the carelessness of the owner. The cipher codes can be deciphered or embezzled by others.

(3) The recognition technologies mentioned above always cause inconvenience to the users in many ways. The use of keys, magnetic cards, IC cards and cipher codes requires either that the recognition media be carried on one's person or that some numbers be remembered, and this causes serious inconvenience to their use.

(4) The above troubles do not occur when using the biological characteristics to recognize, but as a new technology, its recognition technology has much incompleteness. For example, special equipments are needed to pick up images and the algorithms need to be special algorithms, and furthermore, the incompleteness of the picking up equipments and recognition algorithms would often cause a situation of high mis-recognition ratio or rejection ratio.

### SUMMARY OF INVENTION

The present invention provides a fingerprint control system for identity verification, which system can be used conveniently, has a low rejection ratio and low mis-recognition ratio, and is of important application value.

The present invention provides a fingerprint recognition method, which includes following steps:

a. Calculating a direction field and a quality field of the obtained fingerprint image, and judging whether the fingerprint quality is qualified or not;

b. Filtering and binarizing the image of the qualified fingerprints and extracting the characteristic data of the fingerprints from the binarized fingerprint image;

c. Comparing the characteristic data of the fingerprints with the fingerprints in the fingerprint characteristic data memory, and obtaining the recognition result according to the comparison,

Wherein, the direction field of the fingerprint image is locally corrected by using the local preponderance method.

The present invention also provides a fingerprint control method, which includes following steps: collecting fingerprints; performing fingerprint recognition according to the fingerprint recognition method described above; and sending and executing corresponding control commands according to the recognition results.

The present invention also provides a fingerprint control system, including:

a fingerprint collecting subsystem, including a fingerprint image input device for inputting fingerprint images;

a fingerprint recognition subsystem, including a fingerprint image memory, a fingerprint characteristic data memory, and an image processor, which image processor performs the processing and recognition to the fingerprint images according to the fingerprint recognition method described above; and

a driving and executing subsystem for carrying out corresponding control commands according to the recognition results of the fingerprint recognition subsystem.

### BRIEF DESCRIPTION OF THE DRAWINGS

FIG. 1 is a block diagram of a fingerprint control system.

FIG. 2 is a flow diagram of the fingerprint control system.

FIG. 3 is a principle block diagram of an optical fingerprint collecting subsystem.

FIG. 4 shows the calculation manner of a direction value of each pixel point in the calculation of a direction field.

FIG. 5 shows a flow diagram of the fingerprint image filtering and binarizing process.

FIG. 6 shows a program flow chart of a fingerprint comparison module.

### DETAILED DESCRIPTION OF PREFERRED EMBODIMENTS

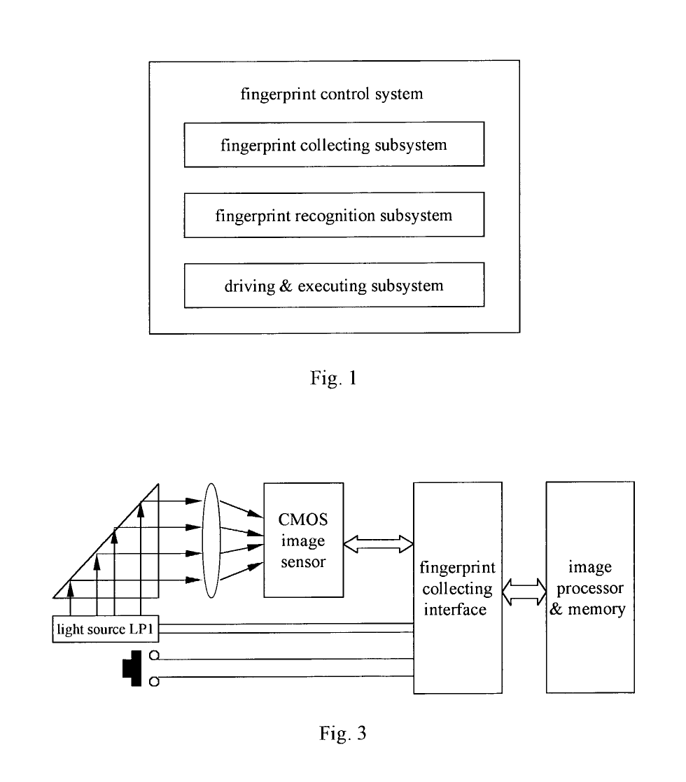

A fingerprint control system mainly consists of a fingerprint collecting subsystem, a fingerprint recognition subsystem and a driving and executing subsystem, and the block diagram of which is shown in FIG. 1. In the system, the fingerprint collecting subsystem corresponds to the input section of the system, the driving and executing subsystem corresponds to the output section of the system, and the fingerprint recognition subsystem corresponds to the controller of the system and is the core section of the whole system.

The fingerprint control system first collects fingerprints through the fingerprint collecting subsystem, and stores the fingerprint images into the image memory. Then according to known theory, the characteristic data, such as the starting points, terminal points, divergences, conjunctions and center and fingerprint grain types or the like, of the fingerprints stored in the memory is extracted and stored into a fingerprint characteristic data memory. When two fingerprints are to be compared, in fact the comparison is performed by use of the characteristic data of two fingerprints, while the characteristic data of the fingerprints is shifted and rotated. And if the number of the coincident maximum characteristic data is greater than a predetermined number, the two fingerprints can be considered to be the same, that is, the comparison is successful. In actual application, the characteristic data of the fingerprints is usually stored in the fingerprint characteristic data memory in advance. And when the comparison is required, after a fingerprint is collected in site and the characteristic data of the fingerprint is extracted, the comparison is performed to judge whether the fingerprint coincides with the fingerprint in the fingerprint characteristic data memory. If it does, a corresponding control command is sent, which control command carries out a corresponding mechanical operation (such as unlocking operation), or a corresponding authorization or the like. Which type of control command is carried out depends on the particular system in actual application.

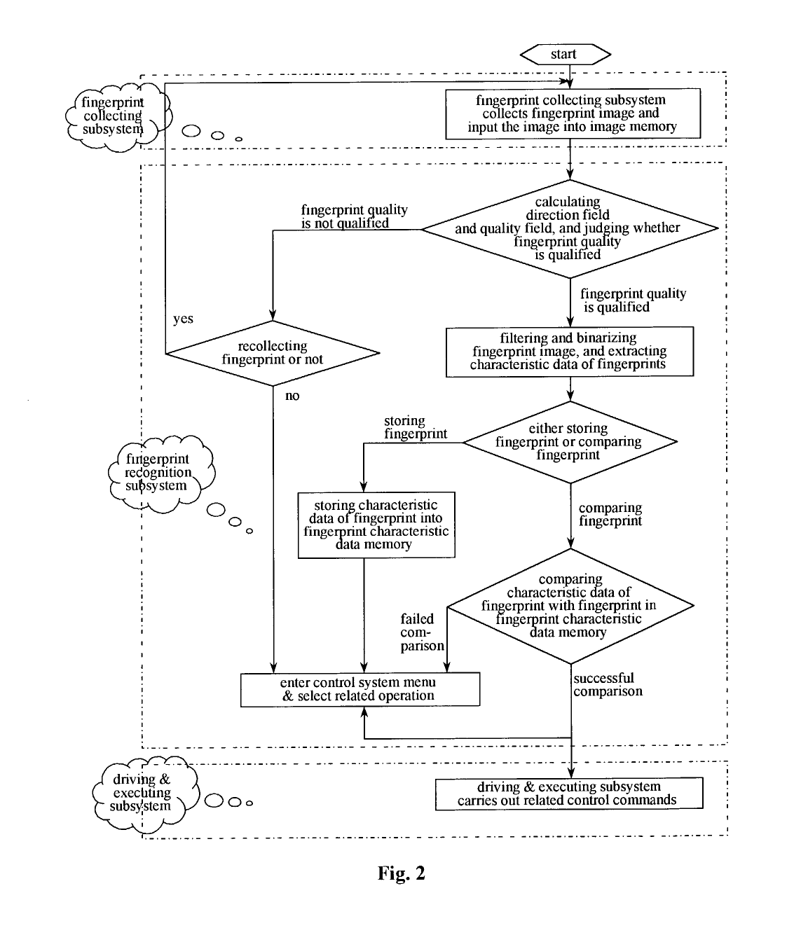

The flow chart of the fingerprint control system is shown in FIG. 2. In this system flow chart, It should be noted that: (1) It is designed, according to the different function requirements of the specific fingerprint control system, whether the fingerprint control system carries out a fingerprint storing operation or a comparison operation. And if the system functions are different, the operations particularly carried out are different accordingly. However, in case of the fingerprint recognition subsystem of any system, the steps in the flow chart must be carried out. (2) When entering the control system menu to select a related operation, the specific operation is determined by the specific control system, and if the system function requirements are different, that will lead to different menu operation of the system. (3) The flow chart of the fingerprint control system is planned from the viewpoint of a control system, that is, there is included input information—the collection of the fingerprints; the processing of the information—extracting the characteristic data, and comparing with the fingerprints in the fingerprint characteristic data memory to see whether they are the same fingerprint; and also the output of information—if the fingerprint comparison is successful, corresponding control information is output so as to make the executing mechanism carry out related operations.

The technical solution of this invention is illustrated in detail as follows.

A. Fingerprint Collecting Subsystem

The fingerprint collecting subsystem, when collecting fingerprint images, can be realized by using different solutions. For example:

(1) Using Optical Principles to Collect Fingerprint Images

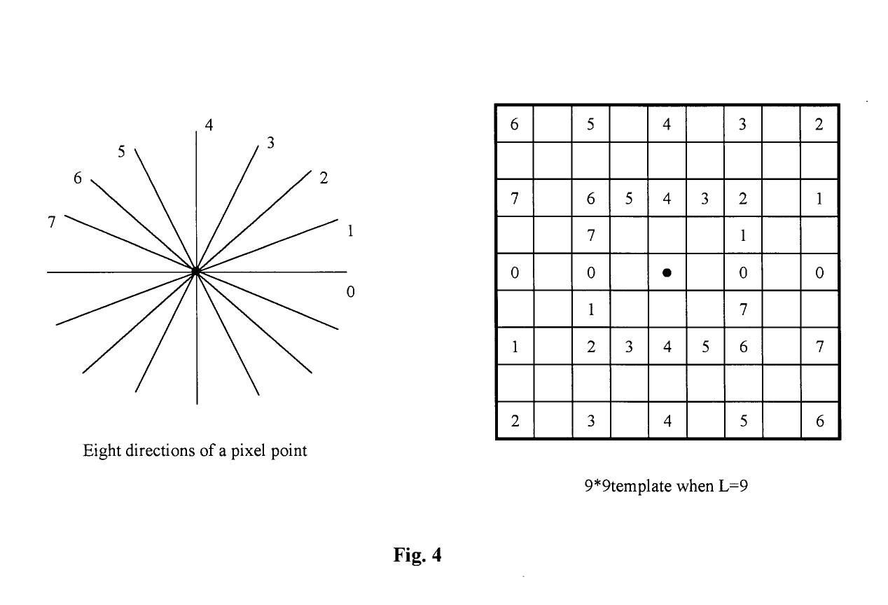

As shown in FIG. 3, an optical collecting assembly is composed of a triangle prism, a light source, and a CMOS image sensor. A planar light source LP1 is used to irradiate a surface of the triangle prism from below, and when a finger is put on the prism surface, the light beam is reflected, and an image is formed on the CMOS image sensor through a lens and is converted, by a A/D converter in the CMOS image sensor, into a digital signal and output to an image processor and a memory;

(2) Using Electrical Capacitor Principles to Collect Fingerprint Images

In a capacitance collecting assembly, the voltage difference, between before and after a finger being put on a fingerprint sensor, is obtained by the sensor, and converted, by a A/D converter, into a digital signal and output to an image processor and a memory;

B. Fingerprint Recognition Subsystem

A main task of the fingerprint recognition subsystem is to process the input fingerprint information. In particular, the fingerprint recognition subsystem will complete the following three operations: (1) Calculating a direction field and a quality field of the fingerprint images, and rejecting the unqualified fingerprints; (2) Filtering and binarizing the qualified images, and extracting the characteristic data on the binarized fingerprint image; (3) Comparing the fingerprint collected in site with the fingerprint in the fingerprint characteristic data memory to see whether the comparison is successful (whether the fingerprint in site and the fingerprint in fingerprint characteristic data memory is the same fingerprint).

The fingerprint recognition subsystem is composed of a fingerprint image memory, a fingerprint characteristic data memory, an image processor and a man-machine interface or the like. Wherein, the image processor completes most functions of processing and comparing of the fingerprint images or the like, and is the core of the fingerprint recognition subsystem, with the performance of the whole fingerprint control system being directly affected by the speed and performance of the image processor.

The method of realizing the fingerprint recognition subsystem is described in detail in the following.

(1) Calculating a Direction Field and a Quality Field to Judge Whether the Quality of the Fingerprint Image is Qualified

The image processing in this phase mainly completes two tasks: calculating a direction field of the fingerprint, and judging whether the quality of the fingerprint image is qualified. Wherein, the direction field is the input information which is indispensable in the successive processing of the fingerprint image (such as image filtering, binarizing and extracting fingerprint characteristic data etc.). The direction field image can roughly describe the whole modality and the local flow direction of the fingerprint image, and has continuity and local parallelism the same as the fingerprint image. The change tendency of the whole flow direction of the direction field can be used to judge the fingerprint grain type of the fingerprint accurately. If the direction field is tracked in a small scope, the position at which the fingerprint center and triangle exist can be determined according to the change rule of the direction field. At the same time, when the fingerprint is collected by the fingerprint collecting subsystem, the quality of the collected fingerprint image may be poor because of the affecting of the some physiological factors (such as desquamation, too much or too little perspiration secretion) and stain, which make the recognition difficult, thereby the control of the fingerprint image collecting quality is necessary. In addition, the fingerprint image collecting quality is an important index for making fingerprint collection, and the fingerprint quality will directly affect the fingerprint grain type classification and the ratio of correct extraction of the characteristic data. And in the actual application and experiment testing, it is also shown that the rejection ratio of the fingerprint of poor quality is considerably high. In view of practicability, the quality of the fingerprint image is judged, and the unqualified fingerprint will not be processed subsequently.

The particular method of realizing this phase of image processing is described in detail as follows.

I. Calculating Direction Field

The calculation of the direction field is mainly divides into three steps: calculating the pixel-point-based direction field; next, calculating the fingerprint-image-block-based direction field; and last, correcting the obtained direction field.

The Pixel-Point-Based Direction Field

Firstly, the directions are defined for every pixel point of the collected fingerprint image. Based on the theoretic requirements and the convenience in calculation, as shown in FIG. 4, for every pixel point a predefined L*L (L≧9+4*k, k is a non-negative integral) template is used, on which eight dispersed directions (expressed as 0, 1 . . . , 7, respectively) are defined.

The pixel (i, j), the direction of which is to be calculated, is placed on the center of the template, and S_k (k=0, 1, . . . , 7) is calculated, wherein S_k is equal to the sum of the gray scale values of several pixel points indicated as number k. For example, when L=9,

S_{—}k=I(i−2, j−4)+I(i−1, j−2)+I(i+1, j+2)+I(i+2, j+4).

The sum of the gray scale values in other directions can be obtained by similar calculations.

The gray scale maximum S_q and minimum S_p in the eight directions are obtained respectively.

S_{—}p=minS_{—}k(k=0, 1, . . . , 7)

S_{—}q=maxS_{—}k(k=0, 1, . . . , 7)

Then, the direction of the pixel point is determined by judging whether the pixel point is located on a ridge of the fingerprint image or in a valley of the fingerprint image. When the pixel point is located on a ridge of the fingerprint image, the gray scale maximum S_q is taken as the direction of the pixel point; and when the pixel point is located in a valley of the fingerprint image, the gray scale minimum S_p is taken as the direction of the pixel point. By use of above calculations, the direction of every pixel point can be quantified into values of the eight directions (0, 1, . . . , 7).

The Block-Based Direction Field

When the change condition of the fingerprint grain lines are observed, it is found that the pixel-point-based direction field is obviously too small to be suitable for reflecting the run direction of the fingerprint grain lines. Therefore it is require that the fingerprint gray scale image should be divided into blocks based on the pixel-point-based direction field. Firstly, the fingerprint gray scale image is divided into squares, and the direction of every square small block is counted, so as to describe the running direction of the fingerprint grain lines in the fingerprint image, in order to provide a good base for the subsequent process.

To obtain the block-based direction field, firstly, the fingerprint image is divided into squares. The sides of the squares are taken as LP pixel points, then LP*LP pixel points are contained in every square small block, that is, the direction values of LP*LP pixel points are contained. Next, for every square small block, a direction value having the maximum number is found, and is taken as the direction value of the square small block, for example defined as D (i, j). Thus a block-based direction field is obtained. If there is no special illustration in the following, the direction fields to be discussed are all block-based.

The Correction of the Direction Fields

The correction of the direction fields is carried out in two steps. First, by using of the local preponderance method the direction field of the fingerprint is locally corrected. On the base of the square division of the fingerprint image, L*L (L is an optimum value obtained by theory calculation and testing verification) template based on blocks is used, the center of which template is just located on the small block to be adjusted for its direction. And a low pass filtering method is used to realize the local correction of the direction field. Next, the integral correction of the direction field is performed. As to directional disorder of large area, it is difficult for the local correction to function. Therefore, different integral templates are designed according to the classification of the fingerprint grain types (the design of those templates is based on long term research of the fingerprint pattern), and are used to adjust the integral direction.

II The Control of the Fingerprint Quality

The gradient distribution of gray scale on the every fingerprint image sub-block is obtained while the direction field is calculated, with every sub-block being one or more of the squares described above, then the cosine of an angle between the gradients is calculated, and when the cosine value is less than a given threshold value, an ambiguity is given to this area; meanwhile the non-continuity of the direction field is calculated to give another ambiguity of quality of that area, and finally the two ambiguities are combined to give the quality level of that area. For the whole image, when the number of the sub-blocks with low quality level is more than a given value, then that image is determined as unqualified. For the unqualified fingerprint images, any subsequent processing will not be performed.

Through the image processing described above, the system outputs two groups of array parameters, i.e., the quality field data and direction field data of the block-based fingerprint image.

(2) Filtering and Binarizing the Fingerprint Image, and Then Extracting the Characteristic Data of the Fingerprint

For the qualified fingerprint image, the fingerprint recognition subsystem continues the processing in following two steps: first, the whole fingerprint image is filtered and binarized; next, the characteristic data is extracted from the binarized fingerprint image.

I The Filtering and Binarizing Processing of the Fingerprint Image

In view of the fact that the noise interference exists when most of fingerprint images are collected, some necessary processing must be done before binarizing to remove the noise appeared on the fingerprint images because of the existence of dust, sweet stain etc., so as to highlight the fingerprint grain characteristics of the original fingerprint. Furthermore, in order to extract the characteristic data of the fingerprint image, the original fingerprint image of 256 gray scales must be transformed into the fingerprint image of 2 gray scales (there are only two gray scales, i.e., black and white).

The specific method of realizing the preprocessing and binarizing is as follows: first, according to the 256 gray scale image of the fingerprint, the direction field data and quality field data information, a directional filtration is performed with respect to each sub-block of fingerprint image, and the ridge density of the fingerprint grain lines is calculated by means of the Fourier analysis method. Next, according to various parameters of ridge density, the direction field data and the like, a Gabor filter is configured and the fingerprint image is filtered, and in every fingerprint image sub-block, in the direction of a straight line section perpendicular to the fingerprint grain line, the image is binarized with the mean gray scale value on the straight line section as a threshold value, and then the original 256 gray scale fingerprint image is transformed into a 2 scale gray image. Finally, the template is constructed by means of mathematical morphology, and the border of the fingerprint image after the binarizing is smoothened to remove the noise such as burrs, isolated points and the like.

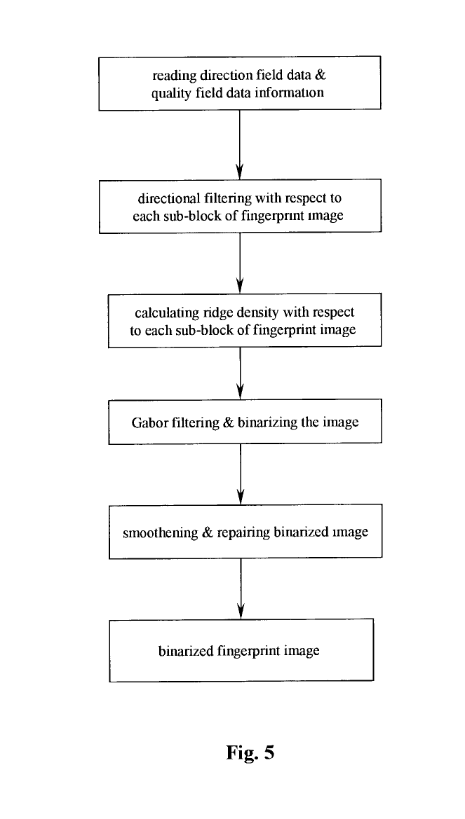

The flow chart of filtration and binarizing of the fingerprint image is shown in FIG. 5.

II Extracting the Characteristic Data of the Fingerprint

In the fingerprint recognition subsystem, storing the fingerprint means storing the characteristic data of the fingerprint image but not storing the actual fingerprint image. When two fingerprints are compared, the characteristic data of the two fingerprints are compared, rather than that the images of the two fingerprints are compared directly. In this sense, the accuracy of extracting the characteristic data directly relates to the success or failure of the whole fingerprint recognition system. The characteristic data of the fingerprint substantially represents the fingerprint image.

The extraction of the characteristic data of the fingerprint is performed mainly on the binarized fingerprint image. Referring to the direction field information obtained above, the characteristic data of the fingerprint, such as coordinates and directions of divergent points and terminal points of the fingerprint grain lines, are extracted according to the modality features of the fingerprint grain lines. The extraction of the characteristic data of the fingerprint is a method to determine the characteristic points of the fingerprint image by means of various preset fingerprint characteristic template according to long period of study of the modality features of the characteristic points of fingerprints.

There are always some false characteristics in finally extracted fingerprint characteristics because of the fingerprint image quality and the limitation of the image filtration and binarizing processing method. Therefore, according to the features of the true characteristics, it is required that the quality of every characteristic point is verified to give confidence information, which can provide some additional information for the comparison algorithm.

(3) Comparing the Fingerprint Collected in Site With the Fingerprint in the Fingerprint Characteristic Data Memory

When it is intended to judge whether two planar figures are the same or not, it will naturally come up to judge whether the two figures coincide within an error range, and if so, they are believed to be the same, and if not, they are not believed to be the same. The fingerprint comparison technology is of the same principle as above, and for two fingerprints to be compared, the process to be performed by the following comparison module is how to judge whether the fingerprints coincide within an error range,

The characteristic data extracted from the processed fingerprint image obtained by the finger collecting subsystem includes coordinate, direction and confidence information of starting points, terminal points, conjunctions and divergences, etc. which are the basic data for comparing fingerprints.

The fingerprint has a relative stability. The characteristic points are the best expression of the stability. First the matching is performed according to the compound pattern composed of features (that is, the compound structure composed of coordinate, direction and confidence, etc. information of characteristic points), then many factors such as the number of the matching characteristic points, the confidence, the size of the coincided area and the like, are combined to determine the comparability between the two fingerprints, and a threshold value is used to judge whether two fingerprints are the same fingerprint.

If comparability is more than the threshold, it is considered that the two fingerprints coincided with each other. But if less or equal to the threshold, they do not coincide, i.e., the two fingerprints are not the same one.

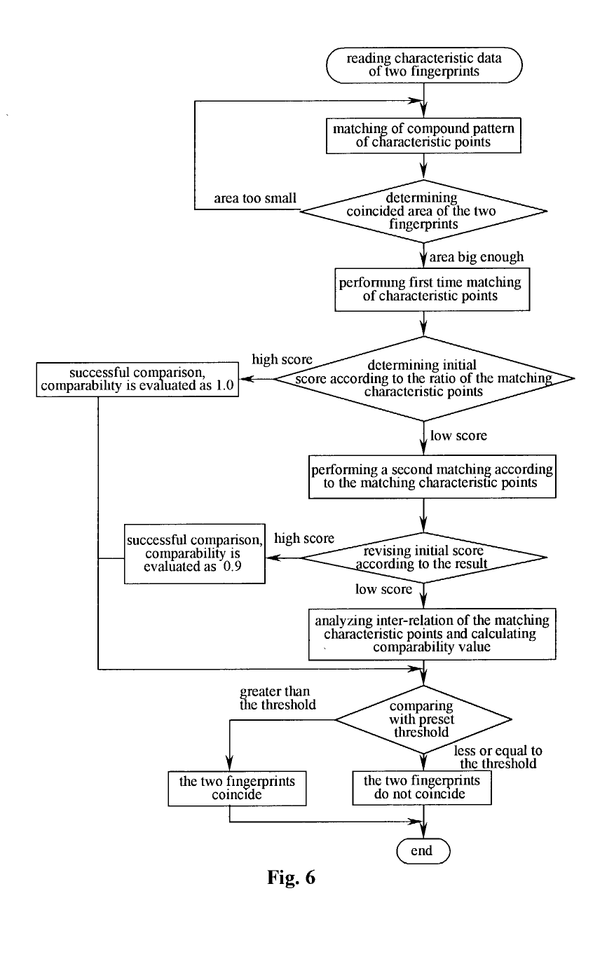

The flow chart of the fingerprint comparison is shown in FIG. 6.

C. Driving and Executing Subsystem

The fingerprint comparison module can judge whether two fingerprints coincide, and also can judge whether the fingerprint collected in site coincides with the fingerprint in the fingerprint database. If they coincide, a corresponding control command is sent, which carries out either a corresponding mechanical operation (such as unlocking operation in door admittance control), or a corresponding authorization or the like. Which kind of control command is carried out correlates with the particular system in actual application. For example, when the system is a door admittance system, the control commands can transmitted to an executing mechanism (locking device) by a wireless transmission module, and also can be transmitted to the executing mechanism (locking device) by a wire network, so as to control the executing mechanism to carry out the corresponding action (unlocking).

The most important point in the verification of identity by means of fingerprint is the practicability of the recognition algorithm. The method and system provided by the present invention have low rejection ratio and mis-recognition ratio in actual applications. The present invention can be applied to all respects of identity verification, including door admittance, network safety verification and resident management or the like.

What is to be claimed:

1. A fingerprint recognition method, comprising steps:
a. calculating a direction field and a quality field of an obtained fingerprint image, and judging whether the fingerprint quality is qualified or not;
b. filtering and binarizing the image of the qualified fingerprints, and extracting the characteristic data of the fingerprints on the binarized fingerprint image;
c. comparing the extracted characteristic data of the fingerprints with the fingerprints in the fingerprint characteristic data memory, and obtaining the recognition result according to the comparison,
wherein the direction field of the fingerprint image is locally corrected by use of local preponderance method.

2. A method according to claim 1, wherein the direction field of the fingerprint image is integrally corrected by means of an integral template which is designed according to the fingerprint grain type of fingerprints.

3. A method according to claim 1, wherein in step a, the gray gradient distribution on every fingerprint image sub-block is obtained, the cosine of an angle between the gradients is calculated, and when the cosine value is less than a given threshold value, an ambiguity is given to this sub-block area; and the non-continuity of the direction field is calculated to obtain another ambiguity of that area, and the two ambiguities are combined to give the quality level of that sub-block area.

4. A method according to claim 1, wherein when the number of the sub-blocks with low quality level is more than a given value, then that image is determined as unqualified.

5. A method according to claim 1, wherein in step b, a directional filtration process is performed with respect to each block of the fingerprint image.

6. A method according to claim 1, wherein in step b, the ridge density of the fingerprint grain lines of the fingerprint images is calculated by means of the Fourier analysis method.

7. A method according to claim 1, wherein in step b, according to the ridge density and the direction field data, a Gabor filter is configured to filter the fingerprint image.

8. A method according to claim 1, wherein in step b, for the sub-blocks of the fingerprint image, on a straight line section in the direction perpendicular to the fingerprint grain lines, the image is binarized with the mean gray scale value as a threshold value.

9. A method according to claim 1, further comprising the step of:
sending and carrying out corresponding control commands according to the recognition result.

10. A fingerprint control system, including:
a fingerprint collecting subsystem, including a fingerprint image input device for inputting fingerprint images;
a fingerprint recognition subsystem, including a fingerprint image memory, a fingerprint characteristic data memory, and an image processor, said image processor having means for
a. calculating a direction field and a quality field of an obtained fingerprint image, and judge whether the fingerprint quality is qualified or not;
b. filtering and binarizing the image of the qualified fingerprints, and extracting the characteristic data of the fingerprints on the binarized fingerprint image;
c. comparing the extracted characteristic data of the fingerprints with the fingerprints in the fingerprint characteristic data memory, and obtaining the recognition result according to the comparison, and
a driving and executing subsystem for carrying out corresponding control commands according to the recognition results of the fingerprint recognition subsystem.
